(19) United States
(12) Patent Application Publication
(10) Pub. No.: US 2025/0012142 A1
(43) Pub. Date: Jan. 9, 2025

(54) PROTECTIVE CASE FOR A TRANSMISSION AND MOTOR(S) FOR AN ARCHITECTURAL-STRUCTURE COVERING

(71) Applicant: Hunter Douglas Inc., New York, NY (US)

(72) Inventors: Mark Schwandt, Thornton, CO (US); Ronald Holt, Westminster, CO (US); Sam Nesmith, Erie, CO (US)

(73) Assignee: Hunter Douglas Inc., New York, NY (US)

(21) Appl. No.: 18/755,873

(22) Filed: Jun. 27, 2024

Related U.S. Application Data
(60) Provisional application No. 63/524,962, filed on Jul. 5, 2023.

(51) Int. Cl. E06B 9/322

(52) U.S. Cl. CPC E06B 9/322

(57) ABSTRACT

A protective case arranged and configured to constrain, encapsulate, or at least partially encapsulate, a transmission and one or more motors (e.g., spring motors) associated with an operating system of an architectural-structure covering is disclosed. In use, the protective case is positioned about (e.g., receives) the transmission and one or more motors to prevent the transmission and motor(s) from excessive movement during, for example, shipping, installation, etc., and thus prevent the transmission and motor(s) from damage associated with the interlocking or intercoupling tabs breaking during, for example, shipping.

### CROSS-REFERENCE TO RELATED APPLICATIONS

This is a non-provisional of, and claims the benefit of the filing date of, U.S. provisional patent application No. 63/524,962, filed Jul. 5, 2023, entitled “Protective Case for a Transmission and Motor(s) for an Architectural-Structure Covering,” the entirety of which application is incorporated by reference herein.

### FIELD OF THE DISCLOSURE

The present disclosure relates generally to the field of architectural-structure coverings, and more particularly to a protective case, assembly, or unit arranged and configured to constrain, encapsulate, partially encapsulate, or the like, a transmission and one or more motors (e.g., spring motors) during, for example, shipping, installation, usage, etc. to prevent damage thereto.

### BACKGROUND OF THE DISCLOSURE

Architectural-structure coverings are well known. Generally speaking, architectural-structure coverings may selectively cover an architectural structure such as, for example, a window, a doorway, a skylight, a hallway, an archway, a portion of a wall, etc. (collectively an architectural structure without the intent to limit). Architectural-structure coverings may include a covering that can be extendable and retractable, for example, vertically extendable or retractable (e.g., able to be lowered or raised, respectively, in a vertical direction) between an extended position and a retracted position for obscuring and exposing the underlying architectural structure.

The architectural-structure covering may include a bottom rail attached to a lower edge of the covering. The bottom rail may be utilized to add weight along the lower edge of the covering to encourage the covering to drop by gravity during deployment or extension. In addition, and/or alternatively, the bottom rail may provide a convenient touchpoint for the user to grab the covering to move the covering between the extended and retracted positions. In addition, the architectural-structure covering may also include a headrail for concealing a top portion of the architectural-structure covering.

To move the covering between the extended and retracted positions, some architectural-structure coverings include a rotatable member (e.g., a rod, a shaft, or a roller). In use, rotation of the rotatable member in a first direction may retract the covering while rotation of the rotatable member in a second, opposite direction may extend the covering.

In some illustrated exemplary embodiments, the covering of the architectural-structure covering may be gathered, stacked, or accumulated onto the bottom rail as the bottom rail is being retracted such that in the fully retracted position, the covering is positioned adjacent to the rotatable member and/or headrail. For example, some retractable coverings include a plurality of slats that are raised or lowered by lift cords that are wrapped about or unwrapped from the rotatable member. The lift cords are coupled to, or associated with, the covering, the bottom rail, and/or the rotatable member. In use, rotation of the rotatable member in a first direction wraps the lift cords about the rotatable member causing the bottom rail and hence the covering to retract or raise adjacent to the rotatable member, while rotation in a second direction causes the lift cords to unwrap about the rotatable member causing the bottom rail and hence the covering to move or lower to an extended position.

As will be appreciated by one of ordinary skill in the art, when raising the covering of the architectural-structure covering, the force required to sequentially raise the covering increases. For example, as more of the covering becomes gathered, stacked, or accumulated onto the bottom rail, progressively more force is required to continue to raise the covering. In contrast, when the covering is in the fully extended position, only the bottom rail is supported by, for example, the lift cords. The rest of the weight of the covering is supported by, for example, ladder tape, which may have tilt cables running to, and supported by, for example, the headrail. Since the weight of the covering not resting on the bottom rail is supported by the headrail via the ladder tape), the weight of the covering need not be overcome when initially raising the covering. Only the weight of the bottom rail, and subsequently, the weight of each successive portion of the covering resting onto the bottom rail as the covering comes into contact with the bottom rail as the covering is being raised, needs to be overcome.

In essence, during use, the lift cords and the ladder tape exchange loads as the covering is raised and lowered. The ladder tape does practically all of the supporting when the covering is extended. As the covering is raised, the weight is shifted from the ladder tape onto the lift cords as each successive portion of the covering is picked up by the rising bottom rail and thus is no longer supported by the ladder tape. The implication is that the least amount of force is required to start raising the covering when in the fully extended position, and also the least amount of force is required to maintain the covering in the extended position. Progressively larger force is required to lift and to maintain the position of the covering as the covering is raised until a maximum amount of force is reached at the topmost position, when the covering is in the fully retracted position.

As a result, and regardless of the form of the architectural-structure covering being utilized, operating systems may be incorporated to assist with the added forces associated with raising the covering of an architectural-structure covering. In some embodiments, the operating system may include one or more motors such as, for example, one or more spring motors to provide additional force to balance the weight of the covering so that, when a user raises or lowers the covering, the covering easily moves in the required direction. Similarly, the one or more motors can ensure that the covering maintains its desired position when the user stops raising or lowering the covering. In use, the spring motors are preferably configured as a constant force motor, but as has been observed, the force required to balance the covering varies as the covering is raised and lowered, with the greatest force required in the retracted position and the least amount of force required in the extended position. For this reason, it is usually desirable to incorporate a transmission so that the desired amount of force is provided at all positions of the covering.

One known transmission is described in U.S. Pat. No. 6,536,503, issued Mar. 25, 2003, entitled “Modular Transport System for Covering for Architectural Openings”, with subsequent improvements described in U.S. Pat. No. 11,149,489, issued Oct. 19, 2021, entitled “Transmission for an Architectural-Structure Covering.”

In use, with reference to FIG. 1, in some embodiments, the transmission 10 is coupled to one of the one or more motors 20 via an adapter 15, which is coupled to the motor 20 via interlocking or intercoupling snaps or tabs 18 (terms used interchangeably herein without the intent to limit or distinguish). In addition, when more than one motor 20 is utilized, the motors 20 may be coupled to each other via interlocking or intercoupling tabs 18.

One concern with incorporating a transmission 10 along with one or more motors 20 is that during, for example, shipping, installation, etc. the interlocking or intercoupling tabs 18 may break. In addition, and/or alternatively, the interlocking or intercoupling tabs 18 between the end cap (not shown) of the headrail and the transmission 10 may break. That is, excessive movement may damage the operating system such as, for example, causing the interlocking or intercoupling tabs 18 to break.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a protective case, assembly, or unit (terms used interchangeably herein without the intent to limit or distinguish) arranged and configured to constrain, encapsulate, partially encapsulate, etc., the transmission and one or more motors during, for example, shipping or installation to prevent damage thereto (e.g., a protective case that partially encapsulates the combination of the transmission and motors to protect the transmission-motor assembly during, for example, shipping). In use, the protective case ensures no amount of forces experienced during, for example, shipping, will separate the parts from one another. Thus arranged, in use, the protective case alleviates the failure mode of parts separating during shipping, installation, etc.

A protective case arranged and configured to constrain a transmission and one or more motors of an operating system in conjunction with an architectural-structure covering is disclosed. In some embodiments, the transmission and one or more motors are coupled by interlocking or intercoupling tabs. In some embodiments, the protective case includes a housing including an inner cavity arranged and configured to partially encapsulate the transmission and one or more motors to prevent relative movement of the transmission and the one or more motors.

In some embodiments, the housing includes a projection or spring arranged and configured to, in use, contact an inner surface of a headrail of the architectural-structure covering.

In some embodiments, the projection or spring is integrally formed with the housing.

In some embodiments, the projection or spring extends from a top surface of the housing.

In some embodiments, the housing includes one or more feet to maintain a position of the protective case within a headrail of the architectural-structure covering.

In some embodiments, the one or more feet extend from a bottom surface of the housing.

In some embodiments, the housing includes one or more barbs arranged and configured to contact the transmission and/or motor(s).

In some embodiments, the housing includes a barb extending from an inner surface of the inner cavity for contacting an outer surface of the transmission to prevent the transmission from sliding out of the protective case.

In some embodiments, the protective case includes one or more ridges arranged and configured to provide additional rigidity.

A method of shipping an architectural-structure covering is also disclosed. The method including partially encapsulating a transmission and one or more motors of an operating system associated with the architectural-structure covering with a protective case to prevent relative movement of the transmission and one or more motors and shipping the architectural-structure covering to a desired location.

In some embodiments, after partially encapsulating the transmission and the one or more motors, the protective case, the transmission, and the one or more motors are positioned within a headrail of the architectural-structure covering.

### BRIEF DESCRIPTION OF THE DRAWINGS

FIG. 1 is a perspective, exploded view illustrating an embodiment of a conventional transmission-motor assembly used in an architectural-structure covering;

FIG. 2 is a perspective view illustrating an embodiment of a protective case in accordance with one or more features of the present disclosure, the protective case arranged and configured to receive the transmission-motor assembly shown in FIG. 1;

FIG. 3 is a perspective view illustrating an alternate embodiment of a protective case in accordance with one or more features of the present disclosure, the protective case arranged and configured to receive the transmission-motor assembly shown in FIG. 1;

FIG. 4 is a perspective, exploded view illustrating an embodiment of a protective case in accordance with one or more features of the present disclosure, the protective case arranged and configured to receive the transmission-motor assembly shown in FIG. 1;

FIG. 5 is a cross-sectional view illustrating the protective case positioned within a headrail of an architecture-structure covering;

FIG. 6 is a perspective view illustrating the protective case positioned on an architecture-structure covering; and

FIGS. 7A-7C illustrates various views of an alternate embodiments of a protective case in accordance with one or more features of the present disclosure.

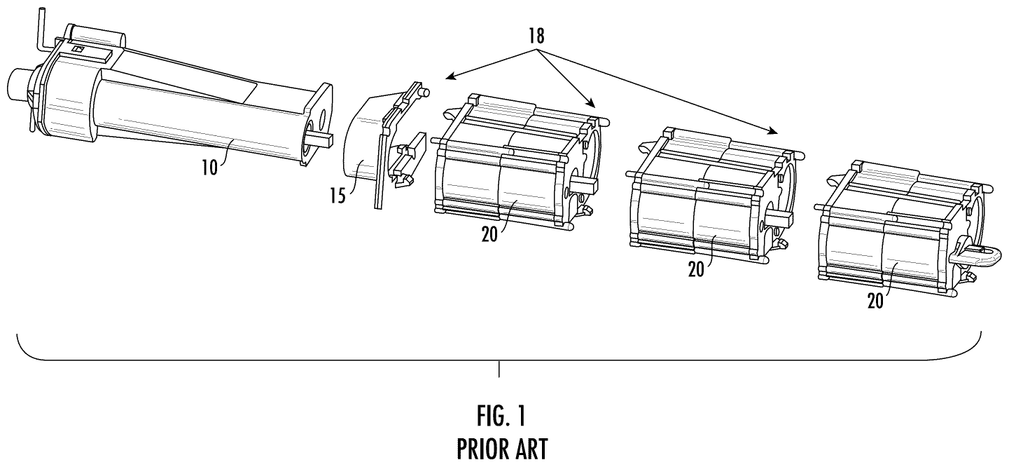

The drawings are not necessarily to scale. The drawings are merely representations, not intended to portray specific parameters of the disclosure. The drawings are intended to depict exemplary embodiments of the disclosure, and therefore are not to be considered as limiting in scope. In the drawings, like numbering represents like elements.

### DETAILED DESCRIPTION

Various features of a protective case, assembly, or unit (terms used interchangeably herein without the intent to limit or distinguish) for constraining, encapsulating, or at least partially encapsulating, a transmission-motor assembly (e.g., a transmission and one or more motors (e.g., spring motors)) of an operating system of an architectural-structure covering during shipping, installation, and thereafter will now be described more fully herein with reference to the accompanying drawings, in which one or more features of the protective case will be shown and described. It should be appreciated that the various features may be used independently of, or in combination, with each other. It will be appreciated that the protective case as disclosed herein may be embodied in many different forms and may selectively include one or more concepts, features, or functions described herein. As such, the protective case should not be construed as being limited to the specific embodiments set forth herein. Rather, these embodiments are provided so that this disclosure will convey certain features to those skilled in the art.

In use, as will be readily appreciated by one of ordinary skill in the art, the transmission 10 and one or more motors (e.g., spring motors) 20 may be incorporated into an architectural-structure covering to assist with balancing the forces associated with raising and lowering the covering of the architectural-structure covering. In some embodiments, the transmission 10 may be operatively coupled to one motor, two motors, or three motors (e.g., spring motors) 20 depending on the size and weight of the covering. In use, the one or more motors 20 provide additional force required to raise and lower the covering, and to maintain a desired position of the covering. As motors (e.g., spring motors) 20 are often configured as a constant force motor, the transmission 10 may be arranged and configured to adjust the supplied force of the motors 20 to balance the supplied force against the varying forces of the covering as the covering is raised and lowered.

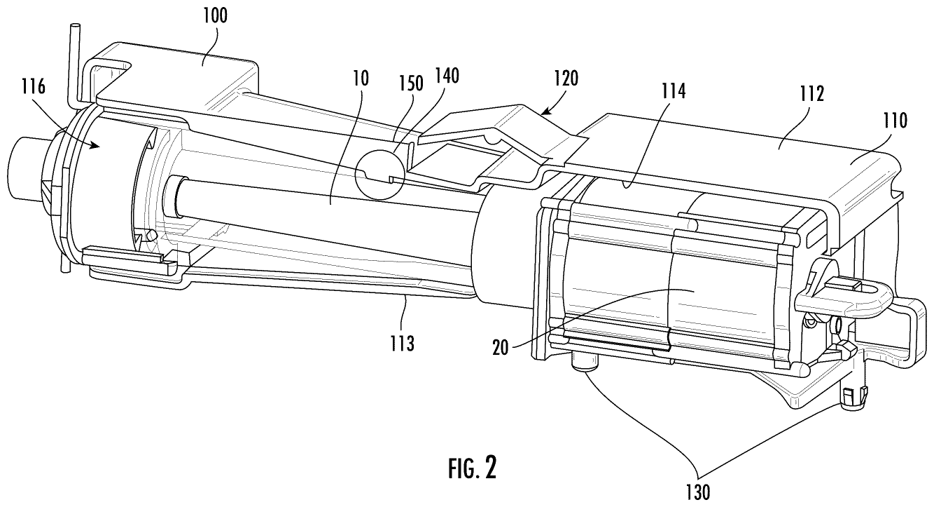

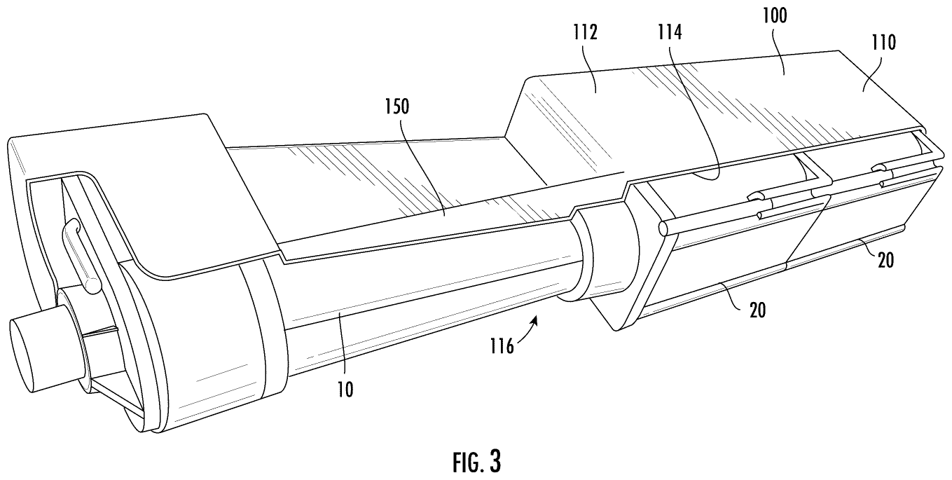

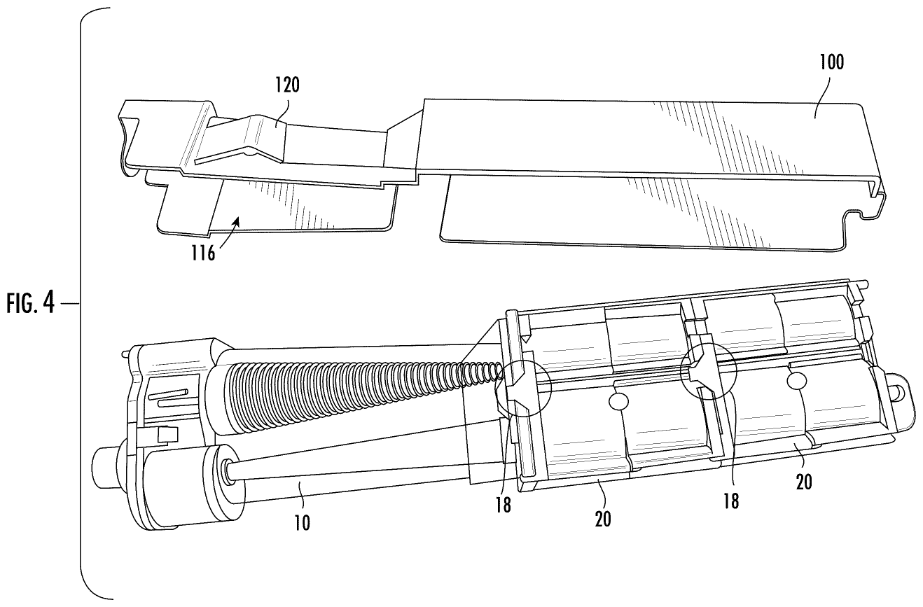

With reference to FIGS. 2 and 3, an example of a protective case 100 in accordance with one or more features of the present disclosure is illustrated, In the embodiment shown, the protective case 100 is arranged and configured to receive the transmission 10 along with one or more motors 20 in a tight fit. In some embodiments, the protective case 100 may provide a press-fit between the inner surfaces of the protective case 100 and the outer surfaces of the transmission 10 and motor(s) 20 thereby holding the components (e.g., transmission 10 and motor(s) 20) in unison. That is, in use, the protective case 100 includes a body or housing 110 including a top surface 112, a bottom surface 113, and an inner surface 114 defining an inner cavity 116. In use, the inner cavity 116 is arranged and configured to receive the transmission-motor assembly (e.g., transmission 10 and motor(s) 20). In some embodiments, the inner cavity 116 is arranged and configured to substantially mimic the size and shape of the transmission-motor assembly (e.g., transmission 10 and motor(s) 20). Thus arranged, when received within the inner cavity 116 of the protective case 100, the transmission 10 and motor(s) 20 are protected from, for example, relative movement which may cause the interlocking or intercoupling tabs 18 to break. By preventing relative movement of the transmission and motors, the likelihood of damage to the interlocking or intercoupling tabs 18 is decreased.

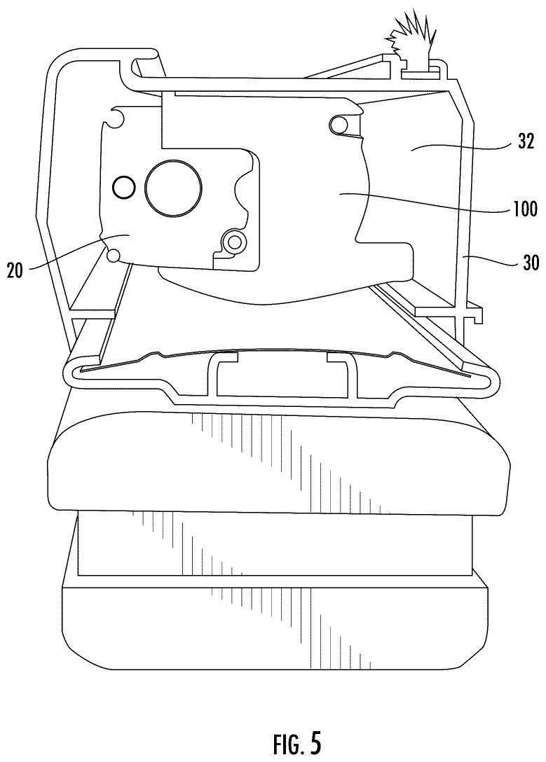

As illustrated in FIG. 2, in some embodiments, the protective case 100 may include a projection or spring 120 such as, for example, a leaf spring, arranged and configured to contact an inner surface 32 of the headrail 30 (FIG. 5) to prevent, or at least reduce, movement of the protective case 100 (e.g., in use, the leaf spring 120 applies a force against the inner surface 32 of the headrail 30 to prevent, or at least inhibit, movement of the protective case 100 relative to the headrail 30 during, for example, shipping, installation, etc.). In some embodiments, the leaf spring 120 may be integrally formed with the housing 110. In some embodiments, the leaf spring 120 may extend from the top surface 112 of the housing 110. As such, the spring 120 may assist in providing a press-fit between the housing 110 of the protective case 100 and the headrail 30. Alternatively, the housing 110 may be configured with, for example, a tight-tolerance to reside within the headrail 30 while preventing, or at least minimizing, excessive movement.

In addition, and/or alternatively, as illustrated in FIG. 2, in some embodiments, the protective case 100 may include one or more projections or feet 130 to maintain the position of the protective case 100 within the headrail 30 during, for example, shipping, installation, etc., thereby preventing excessive movement of the transmission-motor assembly. In some embodiments, the feet 130 extend from the bottom surface 113 of the housing 110. In use, the feet 130 contact the bottom surface of the headrail 30 and/or fabric. As such, the feet 130 prevent, or at least minimize, damage to the fabric and/or may assist in providing a tight-tolerance within the headrail 30 to prevent, or at least minimize, movement of the protective case 100 relative to the headrail 30 during, for example, shipping, installation, etc.).

In addition, and/or alternatively, as illustrated in FIG. 2, in some embodiments, the protective case 100 may include one or more barbs 140 formed on the inner surface 114 of the housing 110. In use, the one or more barbs 140 are arranged and configured to contact the transmission 10 and/or motor(s) 20. That is, for example, as illustrated in FIG. 2, the inner surface 114 of the inner cavity 116 may include one or more barbs 140 for contacting the outer surface of the transmission 10 to prevent the transmission from sliding out of the protective case 100.

Moreover, in addition, and/or alternatively, as illustrated in FIG. 2, in some embodiments, the protective case 100 may include one or more ridges 150. For example, as illustrated, the housing 110 may include a ridge 150 extending longitudinally therewith from the top surface 112 thereof. In use, the one or more ridges 150 are arranged and configured to provide additional support or rigidity to the protective case 100.

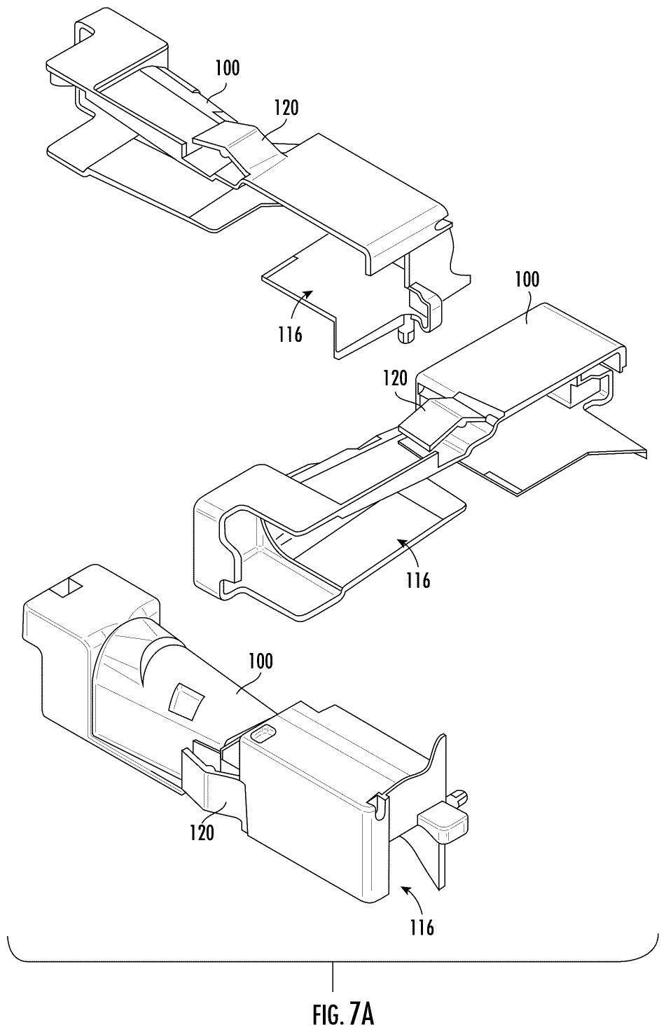

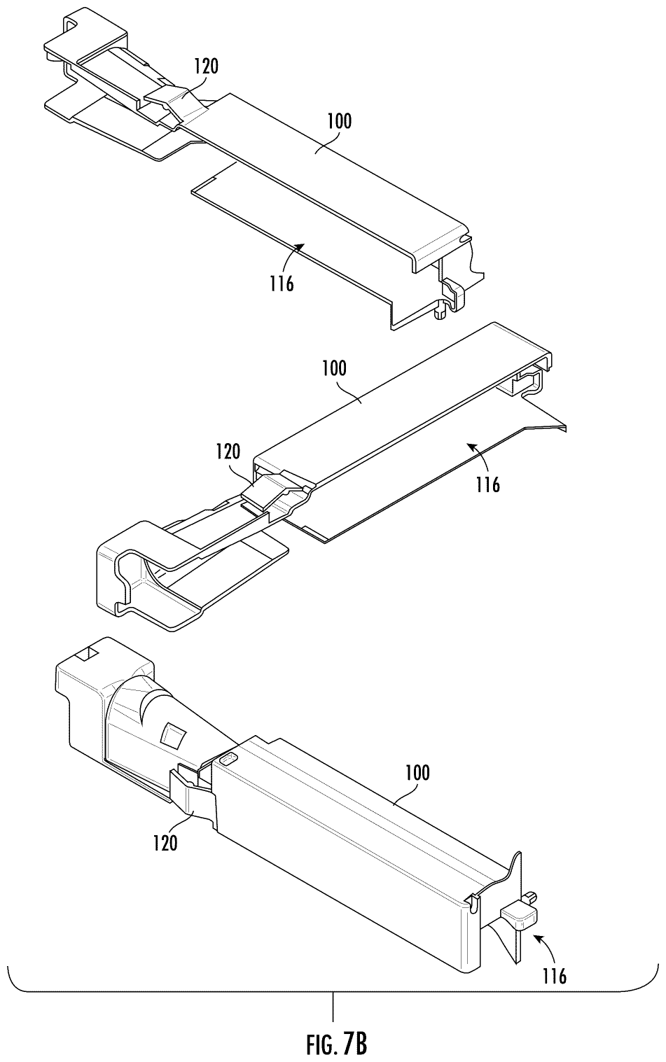

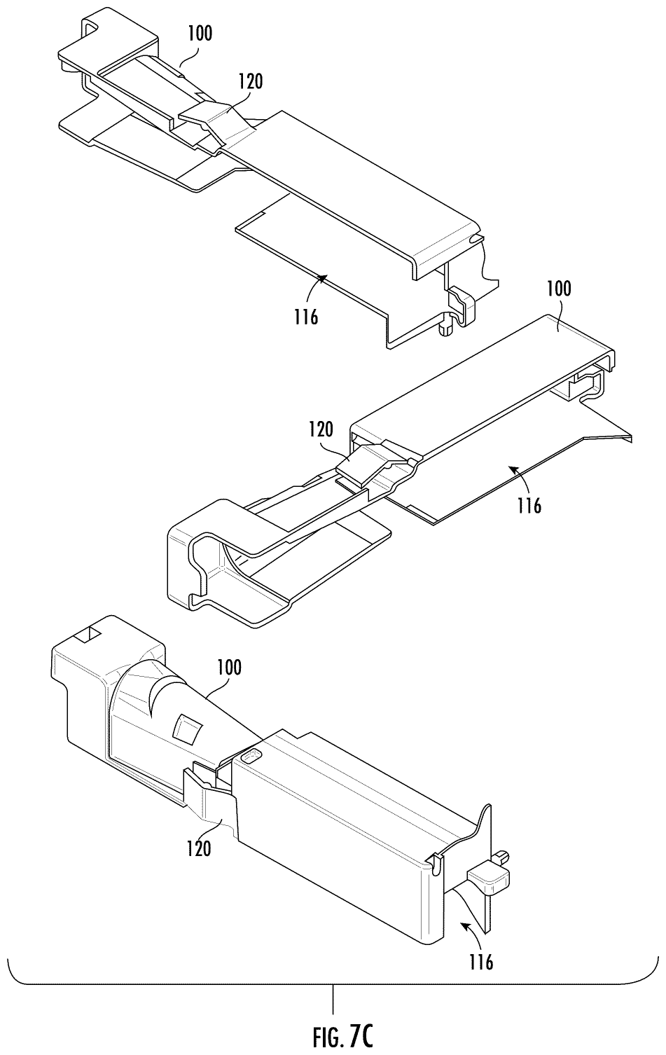

In use, as previously mentioned, the protective case 100 includes an inner cavity 116 having a size and shape that substantially corresponds to the size and shape of the transmission 10 and motor(s) 20 to prevent the motor(s) 20 from moving relative to each other in cases where more than one motor 20 is utilized and/or relative to the transmission 10, and thus prevent the interlocking or intercoupling tabs 18 from breaking or damage. For example, with reference to FIGS. 7A, the protective case 100 may include an inner cavity 116 arranged and configured to receive one transmission 10 and one motor 20 (e.g., protective case 100 is used to receive or constrain the attachment of the transmission to one motor). Alternatively, for example, with reference to FIGS. 7B, the protective case 100 may include an inner cavity 116 arranged and configured to receive one transmission 10 and two motors 20 (e.g., protective case 100 is used to receive or constrain the attachment of the transmission 10 and two motors 20). Alternatively, for example, with reference to FIGS. 7C, the protective case 100 may include an inner cavity 116 arranged and configured to receive one transmission 10 and three motors 20 (e.g., protective case 100 is used to receive or constrain the attachment of the transmission 10 and three motors 20).

For example, with additional reference to FIG. 3, a perspective view of a transmission-motor assembly including one transmission 10 and two motors 20 coupled together and partially encapsulated by the protective case 100 is illustrated. Thus arranged, in use, the transmission-motor assembly is inserted, slide, moved, etc. into the inner cavity 116 of the housing 110 of the protective case 100. Thereafter, the protective case 100 and the transmission-motor assembly may be inserted into the architectural-structure covering such as, for example, within the headrail 30 of the architectural-structure covering as generally illustrated in FIG. 5. Thus arranged, the protective case 100 prevents, or at least substantially inhibits, movement of the motors 20 and transmission 10 relative to each other thereby protecting the transmission-motor assembly from damage during, for example, shipping, installation, etc. (e.g., protective case 100 encapsulates the transmission-motor assembly to prevent the motors 20 and transmission 10 from excessive movement relative to each other thereby preventing the interlocking or intercoupling tabs 18 from breaking during, for example, shipping, installation, etc.).

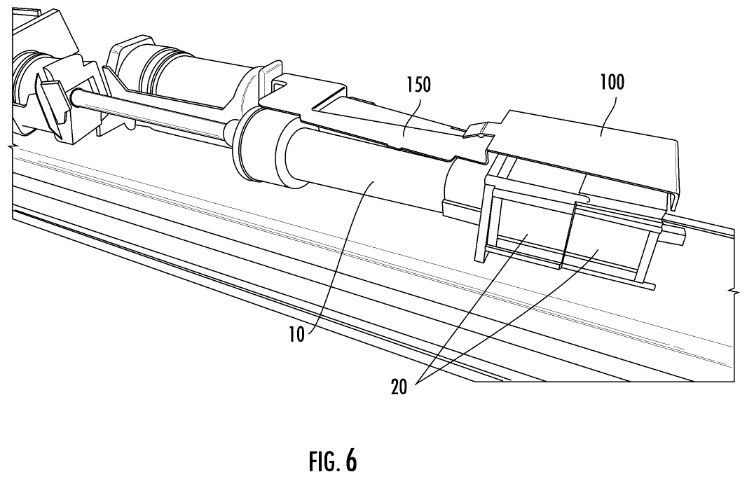

FIGS. 5 and 6 illustrate various alternate views of the protective case 100 partially encapsulating the transmission-motor assembly (e.g., transmission 10 and motors 20). The protective case 100 illustrated in use within the headrail 30 during shipping. FIG. 5 illustrates a cross-sectional view of the protective case 100 partially encapsulating the transmission 10 and motors 20. FIG. 6 illustrates a perspective view of the protective case 100 partially encapsulating the transmission 10 and motors 20.

It should be generally appreciated that although disclosed in connection with one type of architectural-structure covering (e.g., a stacking shade), transmissions and motors, and hence the protective case of the present disclosure, can be used in connection with any suitable type of architectural-structure covering now known or hereafter developed. As such, the present disclosure should not be limited to any particular type of architectural-structure covering unless specifically claimed.

The foregoing description has broad application. Accordingly, the discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority but are used to distinguish one feature from another. The drawings are for purposes of illustration only and the dimensions, positions, order, and relative sizes reflected in the drawings attached hereto may vary.

1. A protective case arranged and configured to constrain a transmission and one or more motors of an operating system in conjunction with an architectural-structure covering, the transmission and one or more motors being coupled by interlocking or intercoupling tabs, the protective case comprising:
a housing including an inner cavity arranged and configured to partially encapsulate the transmission and one or more motors to prevent relative movement of the transmission and the one or more motors.

2. The protective case of claim 1, wherein the housing includes a projection or spring arranged and configured to, in use, contact an inner surface of a headrail of the architectural-structure covering.

3. The protective case of claim 2, wherein the projection or spring is integrally formed with the housing.

4. The protective case of claim 3, wherein the projection or spring extends from a top surface of the housing.

5. The protective case of claim 1, wherein the housing includes one or more feet to maintain a position of the protective case within a headrail of the architectural-structure covering.

6. The protective case of claim 5, wherein the one or more feet extend from a bottom surface of the housing.

7. The protective case of claim 1, wherein the housing includes one or more barbs arranged and configured to contact the transmission and/or motor(s).

8. The protective case of claim 7, wherein the housing includes a barb extending from an inner surface of the inner cavity for contacting an outer surface of the transmission to prevent the transmission from sliding out of the protective case.

9. The protective case of claim 1, wherein the protective case includes one or more ridges arranged and configured to provide additional rigidity.

10. A method of shipping an architectural-structure covering, the method comprising:
partially encapsulating a transmission and one or more motors of an operating system associated with the architectural-structure covering with a protective case to prevent relative movement of the transmission and one or more motors; and
shipping the architectural-structure covering to a desired location.

11. The method of claim 10, wherein after partially encapsulating the transmission and the one or more motors, the protective case, the transmission, and the one or more motors are positioned within a headrail of the architectural-structure covering.
